(19) United States
(12) Patent Application Publication
(10) Pub. No.: US 2024/0167726 A1
(43) Pub. Date: May 23, 2024

(54) THERMAL ENERGY STORAGE

(71) Applicant: Richard William Yemm, Joppa, Edinburgh (GB)

(72) Inventor: Richard William Yemm, Joppa, Edinburgh (GB)

(21) Appl. No.: 18/551,718

(22) PCT Filed: Mar. 30, 2022
(86) PCT No.: PCT/GB2022/050804

§ 371 Date: Sep. 21, 2023

(30) Foreign Application Priority Data
Apr. 2, 2021 (GB) 2104799.8

(51) Int. Cl. F24H 7/02; F28D 20/00; F28F 9/22

(52) U.S. Cl. CPC F24H 7/0208; F28D 20/0039; F28F 9/22; F28D 2020/0078

(57) ABSTRACT

The present invention provides an energy storage apparatus. The energy storage apparatus comprises a storage tank (100, 220) for receiving thermal energy storage fluid (103, 203) therein, a first energy transfer component (107, 205) and a second energy transfer component (106, 206). The storage tank has a first portion and a second portion, each portion having a first end vertically spaced from a second end. The first portion is in fluid communication with the second portion at the respective first ends and at the respective second ends. The first energy transfer component is configured to transfer thermal energy into thermal energy storage fluid in the first portion of the storage tank. The second energy transfer component is configured to transfer thermal energy from thermal energy storage fluid in the second portion of the storage tank. The energy storage apparatus is configured such that operation of at least one of the first energy transfer component and the second energy transfer component causes convective fluid flow of the thermal energy storage fluid from the first energy transfer component towards the second energy transfer component and from the second energy transfer component towards the first energy transfer component.

### FIELD OF THE INVENTION

The present invention relates to an energy storage apparatus and to a method of storing energy using the same.

### BACKGROUND TO THE INVENTION

There is often a need for heat to be provided in a range of commercial and domestic settings, such as for providing hot water and for space heating applications. Broadly, the heat can either be generated and used at the time of the demand or can be generated in advance and stored for subsequent use.

One example of a known system is an indirect hot water store including a heating coil to heat a body of water in a hot water tank. The hot water tank can also include a water-to-water heat exchanger fed from a separate boiler. When hot water is needed (for example for a shower, hot water tap or a heating system to warm the space inside a building), water is passed through another water-to-water heat exchanger in the tank to absorb heat from the heated water in the tank; the heated water from the heat exchanger is supplied to the hot water outlet (such as the showerhead). The supply of heated water to the hot water outlet can continue until the demand stops, or until the hot water in the tank is cooled sufficiently that the water going through the heat exchanger is no longer heated, or is no longer heated sufficiently to meet the needs of the service required. As the thermal energy is extracted from the water in the tank, the heating coil can be used to supply more thermal energy to the water in the hot water tank. It is typical to have stratification of one or more layers of hot water in the tank. The thermal energy extraction heat exchanger is typically provided in an upper region of the tank, so that thermal energy is extracted from the hottest region of the tank. In some examples, the main heating coil can be provided at the bottom of the tank, with an auxiliary heating coil provided near the top of the tank. The auxiliary heating coil is used to ensure the top of the tank can be heated up more quickly to provide a small amount of thermal energy when necessary.

It is a further feature of hot water tanks that the volume of the water in the tank increases as the water is heated. As a result, either a separate expansion vessel, or a header tank, are provided to allow for the increased volume of water to be temporarily removed.

In addition, many areas of the world are seeing greater amounts of electrical energy provided by renewable energy sources, such as wind power, solar power and water-based power. Unlike non-renewable energy sources, there may be significant fluctuations in the amount of power being generated. As a result, a power supply network including a significant number of renewable energy sources may not generate sufficient power to meet all of the energy demands at a given time, whilst there may be amply power at other times. For this reason, energy storage systems have been developed to store energy for later use.

It is in this context that the present inventions have been devised.

### SUMMARY OF THE INVENTION

In accordance with an aspect of the present invention, there is provided an energy storage apparatus comprising: a storage tank for receiving thermal energy storage fluid therein and having a first portion and a second portion. Each portion has a first end vertically spaced from a second end. The first portion is in fluid communication with the second portion at the respective first ends and at the respective second ends. The energy storage apparatus further comprises: a first energy transfer component configured to transfer thermal energy into thermal energy storage fluid in the first portion of the storage tank; and a second energy transfer component configured to transfer thermal energy from thermal energy storage fluid in the second portion of the storage tank. The energy storage apparatus is configured such that operation of at least one of the first energy transfer component and the second energy transfer component causes convective fluid flow of the thermal energy storage fluid from the first energy transfer component towards the second energy transfer component and from the second energy transfer component towards the first energy transfer component.

Thus, stratification of the thermal energy storage fluid can be reduced or even mostly eliminated. It will be understood that once heat is transferred into the thermal energy storage fluid in the first portion by the first energy transfer component, the increase in temperature is accompanied by a corresponding increase in volume of the heated thermal energy storage fluid (and therefore a decrease in density). As a result, the heated thermal energy storage fluid rises in the first portion, pushing the thermal energy storage fluid above out of the way and into the second portion, entraining further fluid along with it, and creating a negative pressure region behind the rising thermal energy storage fluid into which lower thermal energy storage fluid can be drawn. Therefore, thermal energy storage fluid from the second portion is drawn into the first portion.

Separately, or at the same time, when heat is being transferred away from the thermal energy storage fluid in the second portion by the second energy transfer component, the reduction in temperature of the thermal energy storage fluid causes a corresponding decrease in volume of the cooled thermal energy storage fluid in that region (and a corresponding increase in density). As a result, the cooled thermal energy storage fluid falls in the second portion, pushing the thermal energy storage fluid below out of the way and into the second portion, entraining further fluid along with it, and creating a negative pressure region above the falling thermal energy storage fluid into which higher thermal energy storage fluid can be drawn. Therefore, thermal energy storage fluid from the first portion is drawn into the second portion.

It will be understood that the convective fluid flow can be referred to as a cyclic convective fluid flow, the thermal energy storage fluid flowing from the first energy transfer component towards the second energy transfer component by one of the first ends and the second ends of the first and second portions and also flowing from the second energy transfer component towards the first energy transfer component via the other of the first ends and the second ends of the first and second portions. As a result, mixing of the thermal energy storage fluid is promoted, resulting in a more uniform temperature throughout the storage tank, particularly away from the regions directly heated or cooled by the first and second energy transfer components.

By promoting a more uniform temperature, it has been found that an increased energy storage capacity can be obtained, compared to stratified hot water tanks of the prior art of a similar size because there is no longer a region of much cooler thermal energy storage fluid in the storage tank. It has also been found that the efficiency of the energy transfer to and from the energy storage apparatus is improved where the thermal energy storage fluid is circulating around the storage tank in a coherent and ordered way. In other words, a circulatory flow is set up by operation of the first and/or second energy transfer components whereby a convective fluid flow circuit is set up to take a portion of the fluid from the first energy transfer component to the second energy transfer component via the first portion of the storage tank, and for the portion of the fluid to continue to flow in the same direction around the circuit formed by the first and second portions of the storage tank back to the first energy transfer component from the second energy transfer component, via the second portion of the storage tank.

Yet further, it has been found that average temperatures closer to a maximum or minimum safe operating temperature of the thermal energy storage fluid can be achieved (which again increases energy storage capacity) because of the mixing of the thermal energy storage fluid in the storage tank. In stratified water tanks of the prior art, it was necessary heat transfer by convection is substantially incoherent and unstructured. Specifically, when operation of the heating component is ceased, fluid flow in the stratified water tanks of the prior art very quickly stops, with hotter water remaining at the top of the tank, preserving the stratification. Even during operation, the convective flow is unstructured and transient, meaning that mixing between the water in the tank is poor, and it is difficult to ensure that all colder water is passed efficiently through the heater. The coherent, structured convective fluid flow circuit of the present invention provides good energy transfer around the storage tank, with all of the thermal energy storage fluid remaining at a close to uniform temperature throughout the tank, while it is being heated or cooled. It will also be understood that in prior art water tanks having a heating element at the top of the tank, whilst this can result in high temperature water at the top of the tank, the water below the heating element often remains cold due to stratification and the inefficiency of conductive heat transfer in water.

It may be that during operation of the first and second energy transfer components, at least 50% of the thermal energy storage fluid in the storage tank is circulated from the first energy transfer component through the first and second portions of the storage tank, via the second energy transfer component, and back to the first energy transfer component, in less than 2 minutes. Thus, efficient heating of the thermal energy storage fluid in the storage tank is provided.

The energy storage apparatus may be configured such that operation of at least one of the first energy transfer component and the second energy transfer component causes convective fluid flow of the thermal energy storage fluid in a circuit from the from the first energy transfer component to the second energy transfer component and back to the first energy transfer component via a separate route.

It may be that during operation of the first and second energy transfer components, at least 50% of the thermal energy storage fluid in the storage tank is circulated from the first energy transfer component through the first and second portions of the storage tank, via the second energy transfer component, and back to the first energy transfer component, in less than a minute. It may be that during operation of the first and second energy transfer components, at least 50% of the thermal energy storage fluid in the storage tank is circulated from the first energy transfer component through the first and second portions of the storage tank, via the second energy transfer component, and back to the first energy transfer component, in less than 30 seconds.

Even after the first and second energy transfer components cease being active, momentum in the established convective flow circuit ensures that the flow continues for a short time, ensuring that at least partial thermal energy equalisation across the thermal energy storage fluid in the storage tank is provided. The fact that all of the thermal energy storage fluid in the storage tank is continuously and coherently circulating through the first and second portions of the storage tank, via the first and second energy transfer components, ensures that the thermal energy storage fluid is heated much more uniformly with all of the fluid in the tank being heated steadily and together.

Yet another advantage of the inducement of the coherent convective circulation flow is that the size of the first and second energy transfer components can be reduced compared to in prior art solutions, or can be more efficient for a given size, due to the increased effectiveness of the thermal energy dispersal and/or collection as a result of the induced convective circulation flow.

It will be understood that the first end and the second end need not be flat and simply denote relative regions within the portions of the storage tank. Indeed, the first end and the second end need not be a very endmost region of the storage tank, though typically the first end includes an endmost region of the portions of the storage tank, and the second end includes an opposite endmost region of the portions of the storage tank. The second end is at an opposite region of the portions of the storage tank to the first end. Typically, the first end of the first portion is at a substantially similar vertical position in the storage tank as the first end of the second portion. Similarly, the second end of the first portion is at a substantially similar vertical position in the storage tank as the second end of the second portion.

The first portion and the second portion may have substantially equal sizes.

It may be that the storage tank is shaped so as to promote convective flow of the thermal energy storage fluid from the first energy transfer component towards the second energy transfer component and from the second energy transfer component towards the first energy transfer component.

The first energy transfer component may be a heater. The heater may be a resistive heater. The heater may comprise a heating coil. Thus, common heating technology can be used to heat the thermal energy storage fluid. It will be understood that the first energy transfer component may be any other suitable component for transferring heat to the thermal energy storage fluid, for example a heat exchanger.

The first energy transfer component may extend laterally across at least 50% of a lateral extent of the first portion. The first energy transfer component may extend laterally across at least 70% of a lateral extent of the first portion. Thus, the first energy transfer component will transfer thermal energy effectively to the thermal energy storage fluid in the first portion. The first energy transfer component may extend in a direction having a lateral component and a vertical component.

It will be understood that a lateral component can be any direction transverse to a convective flow circulation direction to be induced during operation of the energy storage apparatus. For example, the lateral direction may be in the direction of a width of the first portion. Where the storage tank has a flat, or substantially flat, base, it will be understood that the lateral direction is typically any direction in the same plane as the base, even if offset from the base.

The second energy transfer component may be a heat exchanger. The heat exchanger may comprise a plurality of fins. Thus, common heat transfer technology can be used to transfer thermal energy efficiently and effectively from the thermal energy storage fluid.

The second energy transfer component may extend laterally across at least 50% of a lateral extent of the second portion. The second energy transfer component may extend laterally across at least 70% of a lateral extent of the second portion. Thus, the second energy transfer component will transfer thermal energy effectively from the thermal energy storage fluid in the second portion. The second energy transfer component may extend in a direction having a lateral component and a vertical component.

It will be understood that a heat exchanger typically comprises a heat exchange conduit for directing a heat exchange fluid through the storage tank to exchange thermal energy with the thermal energy storage fluid. The heat exchange conduit is typically in fluid communication with one or more thermal services to transfer thermal energy between the thermal service and the thermal energy storage fluid.

Where the first energy transfer component is an electrical heater and the second energy transfer component is a heat exchanger, it will be understood that the electrical heater and the heat exchanger may be configured to both operate in parallel so that heat can be transferred from the first energy transfer component to the second energy transfer component via the thermal energy storage fluid.

The first energy transfer component may be configured to transfer thermal energy to a lower region of the first portion. Thus, the first energy transfer component is typically provided near the bottom of the first portion of the storage tank. This improves efficiency of the energy storage apparatus by ensuring further thermal energy storage fluid is entrained with the heated thermal energy storage fluid as it rises through the first portion. It also ensures that convective flow occurs through substantially the whole tank volume, rather than excluding a region near the bottom of the tank.

The second energy transfer component may be configured to transfer thermal energy from an upper region of the second portion. Thus, the second energy transfer component is typically provided near the top of the second portion of the storage tank. This improves efficiency of the energy storage apparatus by ensuring further thermal energy storage fluid is entrained with the cooled thermal energy storage fluid as it falls through the second portion. It also ensures that convective flow occurs through substantially the whole tank volume, rather than excluding a region near the top of the tank.

The first energy transfer component may be provided in the storage tank. The second energy transfer component may be provided in the storage tank. Thus, the energy transfer components can be contained within the storage tank, meaning there are no bulky components provided outside the footprint of the storage tank.

A first connection to the first energy transfer component may be provided through an upper wall of the storage tank. A second connection to the second energy transfer component may be provided through an upper wall of the storage tank. It will be understood that the first connection may comprise one or more fluid connections, for example an input fluid connection and an output fluid connection. Additionally, or alternatively, the first connection may comprise an electrical power connection and/or an electrical control connection. For example, where the first energy transfer component is a resistive heater, there will be no need for a fluid connection, but an electrical power connection will be provided. Similarly, the second connection may comprise one or more fluid connections, for example an input fluid connection and an output fluid connection. Additionally, or alternatively, the second connection may comprise an electrical power connection and/or an electrical control connection. For example, where the second energy transfer component is a heat exchanger, there will be an input fluid connection, and an output fluid connection, though there may be no need for an electrical power connection.

The energy storage apparatus may comprise a plurality of first energy transfer components, all for transferring thermal energy to thermal energy storage fluid in the first portion of the storage tank. Each of the plurality of first energy transfer components may be as described hereinbefore. At least two of the plurality of first energy transfer components may be of different types. At least two of the plurality of first energy transfer components may be of the same type. At least two of the plurality of first energy transfer components may be configured to transfer thermal energy to (e.g. may be provided in) the lower region of the first portion of the storage tank. At least two of the plurality of first energy transfer components may be configured to transfer thermal energy to (e.g. may be provided in) respective adjacent regions of the first portion of the storage tank.

The energy storage apparatus may comprise a plurality of second energy transfer components, all for transferring thermal energy from thermal energy storage fluid in the second portion of the storage tank. Each of the plurality of second energy transfer components may be as described hereinbefore. At least two of the plurality of second energy transfer components may be of different types. At least two of the plurality of second energy transfer components may be of the same type. At least two of the plurality of second energy transfer components may be configured to transfer thermal energy from (e.g. may be provided in) the upper region of the second portion of the storage tank. At least two of the plurality of second energy transfer components may be configured to transfer thermal energy from (e.g. may be provided in) respective adjacent regions of the second portion of the storage tank.

A region of the first portion may be separated from a region of the second portion. The regions may be between the respective first and second ends of each of the first and second portions of the storage tank. Thus, the first portion may be separated from the second portion in the regions. In other words, the first portion may be in fluid communication with the second portion via the first end and the second end, but not directly via the region without going via the first end or the second end. As a result, the convective flow is readily induced in the storage tank on operation of the energy transfer components.

The region of the first portion may be separated from the region of the second portion by a baffle in the storage tank. It will be understood that a baffle is substantially any member provided internally within the storage tank for separating the region of the first portion of the storage tank from the region of the second portion of the storage tank. In examples including baffles, it will be understood that the first portion and the second portion can be considered as two parts of a single volume, separated into the two portions by the baffle. Thus, a larger storage tank may be adequately divided to promote convective flow using a simple insert.

The baffle may substantially equally divide the storage tank into the first portion and the second portion in the regions. In some examples, the baffle may be provided entirely within the storage tank and may not extend fully to any side of the storage tank in the regions.

The baffle may extend across the region of the first portion and the region of the second portion. A first flow path for thermal energy storage fluid between the region of the first portion and the region of the second portion may be provided around the baffle and via the second ends of the first and second portions. A second flow path for thermal energy storage fluid between the region of the first portion and the region of the second portion may be provided around the baffle and via the first ends of the first and second portions.

The energy storage apparatus may further comprise one or more temperature sensors for outputting a signal indicative of a temperature of a thermal storage fluid in the storage tank. In some examples, the one or more temperature sensors may be a plurality of temperature sensors positioned to sense the temperature in different portions of the storage tank. Thus, the temperature of the storage tank can be monitored, for example to allow control of the energy storage apparatus to transfer thermal energy thereto and/or therefrom safely and efficiently.

The energy storage apparatus may further comprise a controller. The controller may be configured to operate the first energy transfer component in accordance with a demand signal indicative of a thermal energy transfer request for the energy storage apparatus. Additionally or alternatively, the controller may be configured to operate the second energy transfer component in accordance with the demand signal. Thus, the controller can be used to operate one or both of the energy transfer components safely and efficiently. The thermal energy transfer request may be a request to supply heat. The thermal energy transfer request may be a request to cool.

The controller may be configured to operate the first energy transfer component (and/or the second energy transfer component) in accordance with the demand signal such that a difference between an average temperature of the thermal energy storage fluid in an upper portion of the storage tank and an average temperature of the thermal energy storage fluid in a lower portion of the storage tank is less than 20 degrees Celsius during operation. The difference may be less than 10 degrees Celsius. The difference may be less than 5 degrees Celsius. The difference may be less than 2 degrees Celsius. Thus, a large energy capacity is possible, because the whole of the thermal energy storage fluid can be heated and or cooled to close to the borderline of the safe operating temperatures (e.g. the boiling point when heating a liquid).

The controller may be configured to operate the first energy transfer component (and/or the second energy transfer component) in accordance with the demand signal such that a difference between an average temperature of the thermal energy storage fluid in an upper portion of the storage tank and an average temperature of the thermal energy storage fluid in a lower portion of the storage tank is less than 20 degrees Celsius, 5 minutes after ceasing operation of the energy transfer component(s). The difference may be less than 10 degrees Celsius. The difference may be less than 5 degrees Celsius. The difference may be less than 2 degrees Celsius. Thus, a large energy capacity is possible, because the whole of the thermal energy storage fluid can be heated and or cooled to close to the borderline of the safe operating temperatures (e.g. the boiling point when heating a liquid).

The controller may comprise one or more processors and a computer-readable non-transient memory including instructions to cause the one or more processors to perform the described operations of the controller. The one or more processors may be distributed.

The thermal energy storage fluid may be configured to remain substantially within the storage tank during transfer of thermal energy between the thermal energy storage fluid and one or both of the first energy transfer component and the second energy transfer component. In other words, the storage tank including the thermal energy storage fluid can be considered to be a closed system, though it will be understood that one or more pressure relief valves, and/or filling valves may be provided if necessary. Thus, the storage tank may be a substantially sealed tank. Accordingly, thermal energy stored in the thermal energy storage fluid can be retained more effectively in the energy storage apparatus when the system has been fully or partially charged with thermal energy and is required to store the thermal energy for an extended period of time.

In operation, it may be that the thermal energy storage fluid is a liquid, and the storage take may be filled with less than 10%, by volume, of gas. The storage tank may be filled with less than 5%, by volume, of gas. The storage tank may be filled with less than 1%, by volume, of gas. In some examples, the storage tank may be substantially devoid of gas therein. Accordingly, pressure changes caused by temperature changes of the thermal energy storage fluid within the storage tank can be reduced, or alternatively an expansion volume required to keep the pressure at atmospheric or close to it is reduced.

The storage tank may comprise a flexible wall portion. Thus, a volume of the storage tank can be increased or decreased by movement of the flexible wall portion. It will be understood that the flexible wall portion typically defines an outer wall of the storage tank. The flexible wall portion may be provided in an upper wall of the storage tank. The flexible wall portion may be provided in an uppermost wall of the storage tank. Thus, the portion of the storage tank configured to flex to increase or decrease the volume of the storage tank can be at the top of the storage tank, typically aligned with any gas within the storage tank, and/or at the point in the storage tank where hydrostatic pressure is low.

In some examples, the flexible wall portion may be resiliently deformable, for example formed from a resiliently deformable material. In other words, when the flexible wall portion is deformed from an equilibrium position, there is a restoring force created acting to bring the flexible wall portion back towards the equilibrium position. In some examples, the flexible wall portion may be flexibly deformable, such that the flexible wall portion can be deformed from a first position to a second position, and there is no restoring force acting to bring the flexible wall portion back towards the first position. In some examples, the flexible wall portion may be both flexibly deformable between some positions (without creation of a restoring force) and resiliently deformable in other positions. Thus, the volume of the storage tank can be changed based on the pressure exerted on the flexible wall portion. As a result, volume expansion of the thermal energy storage fluid can be accommodated at least in part by way of the flexible wall portion.

Typically, it will be understood that the flexible wall portion may be more flexible than other portions of the external walls of the storage tank. The flexible wall portion may be less than 20% of the surface area of the storage tank. The flexible wall portion may be less than 10% of the surface area of the storage tank. The flexible wall portion may be less than 5% of the surface area of the storage tank. The flexible wall portion may be greater than 0.1% of the surface area of the storage tank. The flexible wall portion may be greater than 1% of the surface area of the storage tank.

It may be that the storage tank is formed from a material having a linear coefficient of thermal expansion such that an internal volume defined by the storage tank expands or contracts with when heated or cooled at a volumetric rate within 50% of the average volumetric rate of expansion or contraction of the thermal energy storage fluid within its liquid phase. It may be that the storage tank is formed from a material having a linear coefficient of thermal expansion such that an internal volume defined by the storage tank expands or contracts when heated or cooled at a volumetric rate within 20% of the average volumetric rate of expansion or contraction of the thermal energy storage fluid within its liquid phase. It may be that the storage tank is formed from a material having a linear coefficient of thermal expansion such that an internal volume defined by the storage tank expands or contracts when heated or cooled at a volumetric rate within 10% of the average volumetric rate of expansion or contraction of the thermal energy storage fluid within its liquid phase.

It may be that the storage tank is formed from a material having a linear coefficient of thermal expansion such that an internal volume defined by the storage tank expands or contracts when heated or cooled at a volumetric rate within 50% of the average volumetric rate of expansion or contraction of the thermal energy storage fluid within its liquid phase.

The storage tank (e.g. not including the flexible wall portion) may be formed from a material having a linear coefficient of thermal expansion of greater than 30×10⁻⁶ at 20 degrees Celsius. The storage tank may be formed from a material having a linear coefficient of thermal expansion of greater than 75×10⁻⁶ at 20 degrees Celsius. Thus, the linear coefficient of thermal expansion of the storage tank may be greater than that of previous metal-formed storage tanks. As a result, expansion and/or contraction of the thermal energy storage fluid due to changes in temperature can be better matched by expansion and/or contraction of the storage tank, compared to storage tanks formed from metals. The linear coefficient of thermal expansion may be less than 300×10⁻⁶ at 20 degrees Celsius. It will be understood that the tank material typically follows the temperature of the thermal energy storage fluid closely.

In some examples, it may be that the storage tank may be formed from a material having an average linear coefficient of thermal expansion within 50% of the average linear coefficient of thermal expansion of the thermal energy storage fluid. The storage tank may be formed from a material having an average linear coefficient of thermal expansion within 20% of the average linear coefficient of thermal expansion of the thermal energy storage fluid. It may be the average linear coefficient of thermal expansion at temperatures equivalent to the liquid phase of the thermal energy storage fluid. It may be the average linear coefficient of thermal expansion in a temperature range of at least 60 degrees Celsius.

The storage tank may be formed from a material having a volumetric coefficient of thermal expansion of greater than 75×10⁻⁶ at 20 degrees Celsius. The storage tank may be formed from a material having a volumetric coefficient of thermal expansion of greater than 100×10⁻⁶ at 20 degrees Celsius. Thus, the volumetric coefficient of thermal expansion of the storage tank may be greater than that of previous metal-formed storage tanks. As a result, volume changes of the thermal energy storage fluid due to changes in temperature can be better matched by changes in the size of the storage tank, compared to storage tanks formed from metals. The volumetric coefficient of thermal expansion may be less than 600×10⁻⁶ at 20 degrees Celsius.

In some examples, it may be that the storage tank may be formed from a material having a an average volumetric coefficient of thermal expansion within 50% of the average volumetric coefficient of thermal expansion of the thermal energy storage fluid. The storage tank may be formed from a material having an average volumetric coefficient of thermal expansion within 20% of the average volumetric coefficient of thermal expansion of the thermal energy storage fluid. It may be the average volumetric coefficient of thermal expansion at temperatures equivalent to the liquid phase of the thermal energy storage fluid. It may be the average volumetric coefficient of thermal expansion in a temperature range of at least 60 degrees Celsius.

This in itself is considered to be novel and so, in accordance with a further aspect of the present inventions, there is provided a storage tank formed from a material having at least one of a linear coefficient of thermal expansion of greater than 20×10⁻⁶ at 20 degrees Celsius, a volumetric coefficient of thermal expansion of greater than 100×10⁻⁶, and a linear/volumetric coefficient of thermal expansion within 50% of the respective linear/volumetric coefficient of thermal expansion of the thermal energy storage fluid.

Thus, there is provided a tank that can match at least some of the volume changes caused by temperature changes of the thermal energy storage fluid, without the need for a separate expansion vessel.

The storage tank may comprise a first energy transfer component configured to transfer thermal energy between the thermal energy storage fluid in the storage tank and the first energy transfer component. Thus, it may be that the first energy transfer component is configured to transfer energy to the thermal energy storage fluid. Alternatively, or additionally, it may be that the first energy transfer component is configured to transfer energy from the thermal energy storage fluid. The storage tank may comprise the second energy transfer component. The storage tank may comprise substantially any of the features described hereinbefore, for example the flexible wall portion.

The energy storage apparatus may further comprise a support frame having the storage tank provided therein. Thus, the storage tank may be supported in the support frame. The storage tank may be formed from a first material having a first linear (or volumetric) coefficient of thermal expansion. The support frame may be formed from a second material having a second linear (or volumetric) coefficient of thermal expansion. The first linear (or volumetric) coefficient of thermal expansion may be greater than the second linear (or volumetric) coefficient of thermal expansion. Thus, as the temperature of the thermal energy storage fluid in the storage tank is increased, the storage tank may expand at a faster rate than the support frame. Typically, the support frame is configured to support the storage tank in at least five directions, typically being at least in an upwards direction from below, and from at least four side directions, each side direction having a component perpendicular to the upwards direction, for example being substantially perpendicular to the upwards direction. The support frame is configured such that when the storage tank expands to meet the support frame, the storage tank is unable to expand past the support frame in any direction (though it will be understood that the storage tank may expand further together with the support frame). Accordingly, where the storage tank is formed from a material which may become overly pliant, or even liable to yield, above a given temperature, the support frame can be used to brace and reinforce the storage tank as the storage tank is heated to and above the given temperature. Accordingly, the storage tank can be formed from a material which would otherwise be unsuitable to use in an upper region of a desired operating temperature range.

This in itself is considered to be novel and so, in accordance with a further aspect of the present invention, there is provided an energy storage apparatus comprising: a storage tank for receiving thermal energy storage fluid therein; and a support frame (e.g. tank) having the storage tank received therein. The storage tank is formed from a first material having a first linear coefficient of thermal expansion, and the support frame is formed from a second material having a second linear coefficient of thermal expansion, and wherein the first linear coefficient of thermal expansion is greater than the second linear coefficient of thermal expansion.

At a first temperature, a first wall of the storage tank may be configured to be spaced from the support frame. At a second temperature, greater than the first temperature, the storage tank may be configured to have expanded such that the first wall of the storage tank is braced against the support frame. Thus, the storage tank can be braced by the support frame to restrict yield and avoid failure of the storage tank at and above the second temperature.

The first temperature may be less than 70 degrees Celsius. The first temperature may be less than a temperature at which the storage tank is liable to yield. The separation distance between the first wall of the storage tank and the support frame at the first temperature and in a direction normal to the first wall may be no more than the distance by which the storage tank will expand in the direction normal to the first wall at the second temperature.

The separation distance at the first temperature may be less than 5 centimetres. The separation distance may be less than 2 centimetres. In other worlds, it may be that a lateral outer extent of the storage tank at the first temperature is within 5 centimetres (such as within 2 centimetres) of a lateral extent defined by inner surfaces of the support frame. The separation distance may be less than 5% of a width of the storage tank. The separation distance may be less than 2% of a width of the storage tank.

It may be that the storage tank is configured to be spaced from the support frame on at least two lateral sides at the first temperature. It may be that the storage tank is configured to be spaced from the support frame on all lateral sides at the first temperature. It may be that the storage tank is configured to be spaced from the support frame on an upper side at the first temperature.

It may be that the storage tank is configured to have expanded such that at least two lateral sides of the storage tank are braced against the support frame at the second temperature. It may be that the storage tank is configured to have expanded such that at least four lateral sides of the storage tank are braced against the support frame at the second temperature. It may be that the storage tank is configured to have expanded such that an upper side of the storage tank is braced against the support frame at the second temperature.

The storage tank may be formed from plastics material. The storage tank may be formed from polypropylene.

The support frame may be formed from metal. The support frame may be formed from fibre reinforced plastic.

The energy storage apparatus may further comprise (thermal) insulation material surrounding the storage tank. Thus, thermal energy transfer between the storage tank and the external environment via the walls of the storage tank can be reduced and kept to an acceptable level. Where the support frame is present, the insulation material may be provided outside the support frame. In some examples, the support frame may be formed, at least partially, from the insulation material. The support frame may be provided entirely by the insulation material.

It will be understood that insulation material is thermal insulation, being anything configured to reduce thermal heat transfer thereacross compared to the situation where the insulation material is absent.

The insulation material may be provided in an insulation layer surrounding the storage tank on all sides. The insulation layer may be formed from one or more vacuum insulation panels. It will be understood that vacuum insulation panels are typically a panel formed from two spaced layers, having an evacuated (or mostly evacuated) space defined therebetween. End caps are provided around the ends of the vacuum insulation panel to seal the evacuated space.

The insulation material may define a conduit between the storage tank and an external environment outside the energy storage apparatus. The conduit may have a first end, open towards the storage tank, at an upper end of the storage tank, and a second end, open to the external environment, below the first end. The insulation material may comprise an inner wall separating the conduit from the storage tank, and an outer wall separating the conduit from the external environment. In other words, the conduit is defined, at least partially, by the inner wall and the outer wall. The conduit may have an inner wall separating the conduit from the storage tank, and an outer wall separating the conduit from the external environment. Where the support frame is provided, it will be understood that the inner wall also separates the conduit from the support frame.

Thus, there is provided an insulated passageway for fluids to move through the insulation layer whilst still reducing unnecessary heat loss. By having the second end below the first end, cooler air in the ambient environment does not flow up the conduit towards the first end, and warmer air within the insulated area defined by the insulation layer does not flow down the conduit towards the second end. Thus, the arrangement is particularly suited to situations where the storage tank is configured to hold thermal energy transfer fluid to be heated to a temperature greater than the ambient temperature outside the energy storage apparatus.

It will be understood that where the thermal energy storage fluid is to be cooled to a temperature below the ambient temperature, the second end may instead be above the first end.

One or more pipes may run between one or more of the first and second energy transfer components and the external environment, through the conduit. For example, where the second energy transfer component is a heat exchanger, there may be provided an input pipe carrying fluid (e.g. liquid) to the second energy transfer component and an output pipe carrying fluid (e.g. liquid) from the second energy transfer component. The input pipe and the output pipe both pass through the conduit.

A length of the conduit between the first end and the second end may be more than 20 centimetres. The length may be more than 40 centimetres. The length may be less than 2 metres. A conduit may have a cross-sectional area around any pipes or other connections passing therethrough of less than 100 square centimetres. A conduit may have a cross-sectional area around any pipes or other connections passing therethrough of less than 50 square centimetres. A conduit may have a cross-sectional area around any pipes or other connections passing therethrough of less than 20 square centimetres, for example, less than 5 square centimetres. In this way, the heat loss through the conduit is kept very low.

The energy storage apparatus may comprise a thermostatic mixing valve, provided inward of the insulation layer surrounding the storage tank. The thermostatic mixing valve may have a first fluid input in fluid communication with an output of the second energy transfer component (where the second energy transfer component is in the form of a heat exchanger), and a second fluid input in fluid communication with a source of fluid external to the energy storage apparatus. An output of the thermostatic mixing valve may be configured to be connected to a further service requiring fluid at a defined temperature. Typically, the source of fluid external to the energy storage apparatus will be at a temperature different from (e.g. less than) the temperature of fluid output from the heat exchanger providing the second energy transfer component. In this way, fluid can be provided at the defined temperature by proportional mixing of fluid from the first fluid input and from the second fluid input. By providing the thermostatic mixing valve in the insulated space containing the storage tank, heat loss can be reduced, because the fluid that is output from the thermostatic mixing valve is at a temperature closer to the defined temperature. Furthermore, it is beneficial that the thermostatic mixing valve is housed within the insulating shell, as this means that only fluid that is at the temperature required for the service it is supplying leaves the insulating volume, improving safety and reducing heat losses.

The storage tank may be cuboidal. Thus, the storage tank can be easily installed conveniently and with efficient use of space in buildings (such as residential dwellings, or commercial properties). Furthermore, a cuboidal tank is easy to manufacture and insulation panels are readily (and cost-effectively) available as planar flat panels. Typically, it is the external shape of the storage tank that is cuboidal. The internal shape of the storage tank may also be cuboidal. Nevertheless, it will be understood that substantially any shape of storage tank is possible.

The storage tank may have a capacity of at least 100 litres. The storage tank may have a capacity of at least 500 litres. The storage tank may have a capacity of at least 1000 litres. The storage tank may have a capacity of less than 5000 litres. The storage tank may have a capacity of less than 2000 litres.

The storage tank may have a height of greater than 50 centimetres. The storage tank may have a height of less than 3 metres, for example less than 2 metres.

The storage tank may have a lateral cross-sectional area of less than 10 square metres. The storage tank may have a lateral cross-sectional area of less than 8 square metres. The storage tank may have a lateral cross-sectional area of less than 6 square metres. The storage tank may have a lateral cross-sectional area of less than 3 square metres. The storage tank may have a lateral cross-sectional area of less than 2 square metre. The storage tank may have a lateral cross-sectional area of greater than 0.5 square metres.

The storage tank may have a minimum lateral extent of greater than 20 centimetres. The storage tank may have a minimum lateral extent of less than 2 metres. The storage tank may have a maximum lateral extent of greater than 20 centimetres. The storage tank may have a maximum lateral extent of less than 2 metres.

An aspect ratio of a height to a width of the storage tank may be greater than 0.25, for example greater than 0.5. The aspect ratio may be less than 4, for example less than 2.

The energy storage apparatus may be configured to maintain the thermal energy storage fluid below a maximum operating temperature. The maximum operating temperature may be greater than 70 degrees Celsius. The maximum operating temperature may be greater than 85 degrees Celsius. The maximum operating temperature may be less than 100 degrees Celsius. The maximum operating temperature may be less than 98 degrees Celsius. The maximum operating temperature may be less than 95 degrees Celsius. The maximum operating temperature may be less than a boiling point of the thermal energy storage fluid (e.g. below the boiling point of water). The maximum operating temperature may be within 20 degrees Celsius of the boiling point of the thermal energy storage fluid. The maximum operating temperature may be within 10 degrees Celsius of the boiling point of the thermal energy storage fluid. The maximum operating temperature may be within 10 percent of the boiling point of the thermal energy storage fluid, in Kelvin.

It will be understood that the maximum operating temperature is typically the maximum average temperature of the thermal energy storage fluid.

The energy storage apparatus may further comprise the thermal energy storage fluid in the storage tank. The thermal energy storage fluid may be a liquid. The liquid may comprise water. The liquid may comprise at least 90% water, by weight. The liquid may comprise at least 95% water, by weight. The liquid may be water. In some examples, the liquid may comprise glycol.

During a temperature change of the thermal energy storage fluid between a minimum operating temperature of the thermal energy storage fluid and a maximum operating temperature of the thermal energy storage fluid, the thermal energy storage fluid may be under a negative pressure in the storage tank at a first temperature. The thermal energy storage fluid may be under a positive pressure in the storage tank at a second temperature, different to the first temperature. Thus, the storage tank (and the support frame where present) can be sometimes under tension and sometimes under compression as a result of respectively, positive and negative pressure therein, and need not be solely under positive or negative pressure where there is a mismatch between the volume of the storage tank and the volume of the thermal energy storage fluid at a given temperature and ambient pressure. Accordingly, the storage tank need only be capable of withstanding a lower extreme pressure.

During a temperature change of the thermal energy storage fluid between a minimum operating temperature of the thermal energy storage fluid and a maximum operating temperature of the thermal energy storage fluid, the flexible wall portion may be deformed in a first direction from an equilibrium position at a first temperature, and may be deformed in a second direction from the equilibrium position, opposite the first direction, at a second temperature different to the first temperature. Thus, a smaller flexible wall portion can be used because the deformation during temperature change between the minimum operating temperature and the maximum operating temperature need not be all in a single direction from the equilibrium position.

The present invention extends to a method of storing energy using the energy storage apparatus. The method comprises: transferring a first quantity of thermal energy from the first energy transfer component into a first portion of the thermal energy storage fluid in the storage tank; causing convective flow of the thermal energy storage fluid in the storage tank such that the first portion of the thermal energy storage fluid is replaced by a second portion of thermal energy storage fluid at a lower temperature than the first portion of thermal energy storage fluid; and transferring a second quantity of thermal energy from the first energy transfer component into the second portion of the thermal energy storage fluid in the storage tank. Thus, there is a method of adding thermal energy to the storage tank.

The method may further comprise: transferring a third quantity of thermal energy to the second energy transfer component from a third portion of the thermal energy storage fluid in the storage tank; causing convective flow of the thermal energy storage fluid in the storage tank such that the third portion of the thermal energy storage fluid is replaced by a fourth portion of thermal energy storage fluid at a higher temperature than the third portion of thermal energy storage fluid; and transferring a fourth quantity of thermal energy into the second energy transfer component from the fourth portion of the thermal energy storage fluid in the storage tank. Thus, the energy can be extracted again.

The method may comprise causing convective flow of the thermal energy storage fluid in a circuit through the first portion and the second portion of the storage tank, such that the first portion of the thermal energy storage fluid flows from the first energy transfer component to the second energy transfer component and further from the second energy transfer component to the first energy transfer component.

The upper wall of the storage tank may be removable. Thus, the tank can be accessed for maintenance and repair by removing the upper wall. It may be that at least one of the baffle (where present), the first energy transfer component, the second energy transfer component, the temperature sensor(s) (where present) are mounted directly or indirectly to the upper wall. Thus, where the upper wall is removed, the parts mounted to upper wall can also be conveniently removed for maintenance and repair at the same time.

A space may be defined above the storage tank, between the storage tank and the support frame, and/or between the storage tank (optionally also including the support frame), and the insulation layer. Thus, expansion can be accommodated at the top of the energy storage apparatus.

A lower wall of the storage tank may comprise one of a locating protrusion and a locating depression, to cooperate with the other of a locating protrusion and a locating depression in a supporting surface (such as of the support frame and/or the insulation layer). The locating protrusion/depression is typically located centrally, such that expansion of the storage tank occurs symmetrically and all lateral surfaces of the storage tank contact the support frame at substantially the same time. Further, lateral displacement of connections to the storage tank can be reduced.

The invention extends to a heating system comprising the energy storage apparatus. The invention extends to a cooling system comprising the energy storage apparatus.

The energy storage apparatus may be a thermal energy storage apparatus.

### DESCRIPTION OF THE DRAWINGS

An example embodiment of the present invention will now be illustrated with reference to the following Figures in which:

FIG. 1 shows a schematic diagram showing an example of a storage tank;

FIG. 2 shows a schematic diagram showing a further example of a storage tank;

FIG. 3 shows a graph of expansion of storage tanks and water with temperature;

FIG. 4 shows a graph of expansion of a storage tank with temperature, having a pressure differential at a lower temperature limit;

FIG. 5 shows a graph of expansion vessel displacement with temperature, for different storage tanks and filling principles;

FIG. 6 shows a schematic illustration of variation in size of a storage tank;

FIGS. 7 to 9 each shows storage tanks including flexible wall portions;

FIG. 10 shows an example of energy storage apparatus as described herein;

FIG. 11 shows another example of energy storage apparatus as described herein;

FIGS. 12A and 12B show the storage tank within a support frame near a maximum operating temperature and near a minimum operating temperature;

FIG. 13 shows another example of a storage tank; and

FIG. 14 is a flow diagram illustrating a method of operating the energy storage apparatus described herein.

### DETAILED DESCRIPTION OF AN EXAMPLE EMBODIMENT

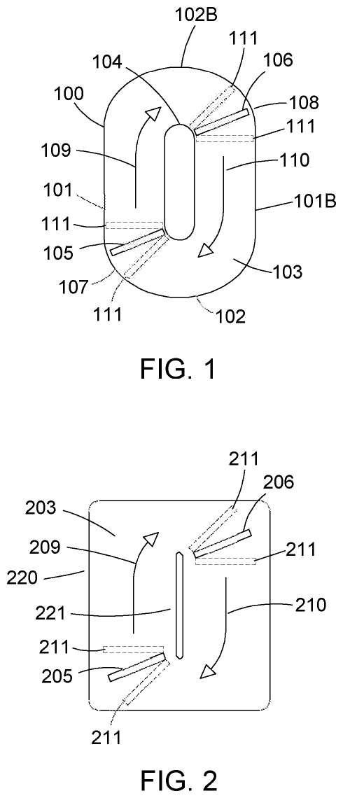

With reference to FIG. 1 the energy storage apparatus comprises a storage tank in the form of a substantially rigid tank 100. The form of the tank is such that it is a continuous conduit forming a closed loop. The conduit is comprised of a first portion and a second portion, in the form of two sections that are oriented in a substantially vertical orientation 101, 101B linked by two sections that are oriented in a substantially horizontal orientation 102, 102B linked together so as to form a closed loop. The cross section of the conduit can be of any shape for example it could be round or it could be rectangular, or it could be of any arbitrary cross section. The cross sectional area of the conduit can be constant all the way round the circuit or for example can be different at different points around the circuit to change or optimise the behaviour.

The tank 100 is filled with a thermal energy storage fluid in the form of a liquid heat storage medium 103, preferably the liquid will have a high Specific Heat Capacity so that it takes a lot of energy to heat the liquid up to a given temperature. For example liquid heat storage medium 103 could substantially comprise water, or it could comprise any other liquid with the desired properties. Other chemicals and compounds may be added to the liquid heat storage medium 102 to prevent adverse processes such as corrosion and/or biological growth without changing the function of the invention. In addition, the liquid heat storage medium 103 will have a property, like the vast majority of liquids, that it will expand and reduce in density as its temperature rises, and contract and increase in density as its temperature reduces.

The tank 100 may be fully filled or may leave an unfilled air or gas space above the liquid heat storage medium without changing this function of the invention, as long as there is sufficient liquid heat storage medium to fill the tank to above the level of the lower surface 104 of the top horizontal linking channel 104 to form a continuous closed loop of liquid heat storage medium in the tank.

One or more first energy transfer components in the form of heating elements 105 to add heat energy to the local liquid heat storage medium 103 around them are mounted in the tank 100 immersed in the liquid heat storage medium 103. In addition, one or more second energy transfer components in the form of cooling elements 106 to remove heat from the local liquid heat storage medium 103 around them is also mounted in the tank 100 immersed in the liquid heat storage medium 103. When heat energy is added to the liquid heat storage medium 103 its temperature will rise and it will expand as a result and become less dense causing it to become more buoyant relative to the cooler liquid heat storage medium 103 around it and therefore rise up. Conversely, when heat energy is removed from the liquid heat storage medium 103 its temperature will fall and it will contract as a result and become more dense causing it to become less buoyant relative to the cooler liquid heat storage medium 103 around it and therefore sink down. This is the process known as convection.

The one or more heating elements 105 to add heat energy are mounted at the lower end of one of the vertical sections of conduit 107. The one or more cooling elements 106 to remove heat energy are mounted near the top of the other vertical section 108. The heating elements 105 and cooling elements 106 to add or remove heat are preferably of a size and form that they, individually or together, cover a significant proportion of the cross sectional area of the conduit in which they are placed.

This arrangement means that if energy is added to the local liquid heat storage medium 103 by the heating element or elements 103 positioned at the lower end of one of the vertical sections of conduit 107 it will warm up and rise up that vertical section of conduit 101 as shown the by the arrow 109. As the said vertical section of conduit 101 is part of a closed circuit, and as the heating element or elements 105 have an area comparable to the area of the conduit, the heated liquid heat storage medium 103 rising up the vertical section will be replaced by cooler liquid heat storage medium 103 from the vertical section 101B of other side of the closed loop tank 100 setting up a circulation of liquid heat storage medium 103 around the closed loop in the direction of arrows 109 & 110 though convection. If the heating is maintained for a period of time a strong and coherent circulation will be set up through convection, with all of the liquid heat storage medium 103 in the tank repeatedly passing through the heating element or elements 105. The key advantage of the circulation mechanism set up by the arrangement of components in the invention ensures that all of the liquid heat storage medium 103 in the tank 100 is heated to approximately the same temperature such that the temperature of all of the liquid heat storage medium 103 in the tank rises steady and together, with no stratification of temperature in the tank 100. Heating can continue in this manner until all of the liquid heat storage medium 103 in the tank 100 has reached the desired temperature whereupon the heating element or elements 105 can be switched off. A particular advantage of this mechanism is that all of the liquid heat storage medium 103 can be heated to close to its boiling point without concern that a small local region will start to boil while a substantial proportion of the liquid heat storage medium 103 remains at well below boiling. The passively created strong and coherent circulation thereby markedly increases the amount of heat energy that can be added to a given volume of liquid heat storage medium 103 without it boiling.

By a similar mechanism if the cooling element or elements 106 to remove heat energy from the liquid heat storage medium 103 are switched on the local liquid heat storage medium around said cooling element will reduce in temperature, become more dense than the liquid heat storage medium 103 around it and therefor sink down the vertical section of conduit 101B as shown by arrow 110. As the said vertical section of conduit 101B is part of a closed circuit, and as the cooling element or elements 106 have an area comparable to the area of the conduit, the cooled liquid heat storage medium 103 sinking down the vertical section is replaced by warmer liquid heat storage medium 103 from the other side of loop setting up a circulation of liquid heat storage medium around the closed loop conduit in the direction of arrows 109 & 110. If the cooling is maintained for a period of time a strong and coherent circulation will be set up through convection, with all of the liquid heat storage medium 103 in the tank repeatedly passing through the cooling element or elements 106. The key advantage of the circulation mechanism set up by the arrangement of components in the invention ensures that all of the liquid heat storage medium 103 in the tank 100 is cooled to approximately the same temperature such that the temperature of all of the liquid heat storage medium 103 in the tank 100 falls steady and together, with no stratification of temperature in the tank 100. Cooling can continue in this manner until all of the liquid heat storage medium 103 in the tank has reached the desired temperature whereupon the cooling element or elements 105 can be switched off. A particular advantage of this mechanism in some applications is that all of the liquid heat storage medium 103 can be cooled to close to its freezing point without concern that a small local region will start to freeze while a substantial proportion of the liquid heat storage medium 103 remains at well above freezing. The passively created strong and coherent circulation through convection thereby markedly increases the amount of heat energy that can be removed from a given volume of liquid heat storage medium 103 without it freezing.

The positioning of the heating element or elements 105 and cooling element or elements 106 as described above is such that the direction of circulation of liquid heat storage medium 103 in the closed loop conduit is the same whether either the heating element or elements 105 or cooling element or elements 106 are activated. This further means that if both the heating element or elements 105 and cooling element or elements 106 are activated at the same time an even stronger coherent circulation will be set up through convection, and will mean that energy from the heating element or elements 105 can be directly and efficiently transferred in part or in full to the cooling element or elements 106. It follows that if the energy added to the liquid heat storage medium 103 is greater than the energy removed, the liquid heat storage medium 103 in the tank will heat up at a rate simply dependent on the difference in heating and cooling. Conversely, if energy removed from the liquid heat storage medium 103 by the cooling element or elements 106 is greater than the energy added by the heating element or elements 105 the liquid heat storage medium 103 in the tank will cool down at a rate simply dependent on the difference in heating and cooling. These properties of the invention confer certain important benefits in the envisaged application.

The precise position, orientation and angle 111 of the heating element or elements 105 and/or cooling element or elements 106 may be chosen to optimise the behaviour and performance of the individual components and system and the system as a whole. For example the heating element or elements 105 and/or cooling element or elements 106 may be placed higher or lower in the vertical section as required, and heating element or elements 105 and/or cooling element or elements 106 may be placed at a greater or lesser angle to the conduit to achieve the best heat transfer and flow characteristics of the individual components and the system as a whole. To minimise stratification of temperature in the tank, preferably at least part of the heating element(s) 105 will be positioned very close to the lowest point in the tank, and a least part of the cooling element 106 will be positioned very close to the highest point in tank. Typically the particular system and requirements will be analysed and experiments conducted to determine the optimum position and angle for each part of the system.

The size and design of the heating element or elements 105 and cooling element or elements 106 can be chosen to meet the design input and output energy rates and to stimulate and maintain the strongest and most stable circulation of the liquid heat storage medium 103 around the closed loop tank 100 as possible. Typically the heating element or elements 105 and/or cooling element or elements 106 with have a size and area similar to the cross sectional area of the conduit in which they are mounted. Typically they will be optimised to maximise heat transfer while minimising the flow blockage and drag presented to the circulation of liquid heat storage medium 103 in the tank 100. Typically their design will be optimised to give a substantially even heating or cooling effect across their whole area to prevent hot or cold spots leading a less coherent and powerful circulation, and in the case of the heating element or elements 105, potentially leading to localised boiling of the liquid heat storage medium 103 and in the case of the cooling element or elements 106, potentially leading to localised freezing of the liquid heat storage medium 103, all of which effects may limit the rate of energy transfer in or out of the tank 100 and ultimately the amount of energy that can be transferred to and stored by a given volume of liquid heat storage medium 103.

While the heating element or elements 105 may be of any type and form, in one preferred embodiment the heating element or elements 105 could comprise one or more long resistive electrical heaters which are bent or shaped into a form spanning the cross sectional area where they are mounted. The heating element or elements 105 could be designed to have a low power density per unit area to avoid local boiling. Alternatively the heating element or elements 105 could be a resistive electrical heating element integrated into a finned heat exchanger with a greater total heat transfer area and thereby a lower power density per unit area and lower temperature difference with the local liquid heat storage medium at a given power, both approaches significantly reducing the chances of local boiling of the liquid heat storage medium 103. There may be a single heating element 105 to take electrical power from one or multiple separate electrical power sources, or there may be a plurality of heating elements 105, of the same or different electrical and power characteristics and ratings, taking electrical power from one or a plurality of sources. In another preferred embodiment the heating element or elements 105 may comprises a fluid-to-fluid heat exchanger instead, such a heat exchanger could be of any form or type but in one preferred embodiment the heating element or elements 106 could each be of the form of multiple tubes with large metal fins of a similar construction to a car radiator. In this embodiment hotter fluid from outside the tank 100 can flow through the tubes in said heat exchanger and thereby add heat energy from the liquid heat storage medium 103 in the tank 100. Such an approach has the advantage that this form of heating element is of the ideal form to perform the function of transferring heat from one fluid to another, and is already a mass produced item using the minimum possible material for the required effect. In a further preferred embodiment such a fluid-to-fluid heat exchanger could be integrated with one or a plurality of electrical heating elements to form a combined fluid-to-fluid and electricity to fluid heating element.

While the cooling element or elements 106 may be of any type or form, in one preferred embodiment the cooling element or elements 106 could each be of the form of multiple tubes with large metal fins of a similar construction to a car radiator. In this embodiment cooler fluid from outside the tank 100 can flow through the tubes in said heat exchanger and thereby extract heat energy from the liquid heat storage medium 103 in the tank 100. Such an approach has the advantage that this form of cooling element is of the ideal form to perform the function of transferring heat from one fluid to another, and is already a mass produced item using the minimum possible material for the required effect.

In an alternative embodiment that functions on exactly the same principle, the form of the tank can be changed or simplified to maximise the volume of heat absorbing fluid within a given set of external dimensions and reduce the cost of the system.

One preferred embodiment of the current invention is shown in FIG. 2. The apparatus shown in FIG. 2 is substantially similar to that of FIG. 1, apart from the hereinafter described distinctions. Here the space in the middle of the conduits is removed and the individual conduit sections are replaced by a simple outer wall of a tank of substantially cuboid form 220 filled with a liquid heat storage medium 203 as before, with a central plate, known as a baffle 221, running across the tank 220 between opposing walls to form a more compact continuous circuit. This arrangement still forms two substantially vertical conduit sections 201, 201B and horizontal conduit sections 202, 202B linked to form a compact continuous circuit. The heating element or elements 205 and cooling element or elements 206 can be arranged in a similar fashion to create a strong an coherent circulation through convection in the direction of arrows 209, 210 when either or both of the heating element or elements 205 and cooling element or elements 206. The position, orientation and angle 211 of said heating element or elements 205 and cooling element or elements 206 can be chosen to optimise the function and performance of the system as a whole in a similar way. To minimise stratification of temperature in the tank, preferably at least part of the heating element(s) 205 will be positioned very close to the lowest point in the tank, and a least part of the cooling element 206 will be positioned very close to the highest point in tank. Such a system works in exactly the same manner as FIG. 1 and as described above, but is more compact for a given energy storage capacity and much more cost effective and easy to insulate.

### Thermal Expansion

The present disclosure also tackles the inefficient, expensive and bulky systems to deal with expansion and contraction of the liquid heat storage medium as it is heated and cooled. This may be due to the inherent thermal expansion properties of the liquid heat storage medium itself or may also be due to the expansion of any gas held above the liquid heat storage medium and additional due to the partial vapour pressure generated by the liquid heat storage medium as it is heated up. The expansion system must either maintain the pressure in the system as close to constant as possible, or as a minimum, must control the rise in pressure such that the system is not over-pressurised. As described in the background section, this is typically achieved by either having a large header tank that the liquid heat storage medium can expand into, or a large enclosed gas space above and/or connected to the liquid heat storage medium vessel of sufficient size that with the combined expansion of the liquid heat storage medium, and any gas or vapour above, does not increase the pressure in the system as a whole to the point that it would over-pressure or burst. As described hereinbefore, such systems are large, expensive, and result in a great deal of heat loss.

Gases invariably expand faster than liquids, so it can be shown that the total expansion volume required can be minimised if there is no gas or partial vapour space above the liquid heat storage medium or in any other parts of the tank system linked to it. Accordingly, in the current invention the tank volume is preferentially fully filled with liquid heat storage medium with no significant gas space. There may of course be a small residual space left by imperfect filling or accumulating through time, but this will be very small compared to the volume of liquid heat storage medium.

Typical materials that make up the tank walls of heat storage tanks are metals such as copper and stainless steel. Such materials have a very low coefficient of thermal expansion, the volume of the tank remains essentially constant across the typical temperature range of operation for such systems. In such systems all of the expansion and contraction of the liquid heat storage medium must be allowed for by one of the means described in the background section and above.

FIG. 3 shows a graph to illustrate a number of characteristics in this regard. To illustrate the effects and features, water has been chosen as the liquid heat storage medium. However, the principles and solutions will be similar whatever the liquid heat storage medium chosen. Firstly, by way of illustration, the graph shows the expansion curve 250 of a volume of water of 1000 litres as it is heated from 10° C. to 95° C. Initially the volume increases slowly with temperature but as the temperature rises the rate of expansion increases markedly. By 95° C. the water has increase to almost 1040 litres, a total expansion of approximately 40 litres from the volume at 10° C. Also shown is the volume expansion of a tank made from metal 252, in this case copper, with a volume of 1000 litres at 10° C. as its temperature is increased across the same range up to 95° C. Stainless steel has a very similar coefficient of linear expansion so would follow a very similar line. Importantly, the tank volume only increases by approximately 4.5 litres across the range. Moreover, as the expansion is governed by linear expansion in all three dimension of the tank, the expansion is linear across the range 10° C. to 95° C. It can be concluded that such a tank would need a header tank of at least 35 litres to take the expansion of the water, or alternatively would require an enclosed gas volume in an expansion vessel of typically more than double this to control the pressure rise to within acceptable safe limits.

In one embodiment of the current invention the tank is made of a material with thermal expansion properties such that the volume expansion and contraction of the tank exactly matches the volume expansion and contraction of the liquid heat storage medium across the temperature range of interest. Such a material would give rise to an expansion curve identical to that of the water 250 (it is not separately labelled as it would not be visible). If the match can be made perfect, the tank can remain sealed with no other mechanism required to prevent a change of pressure inside.

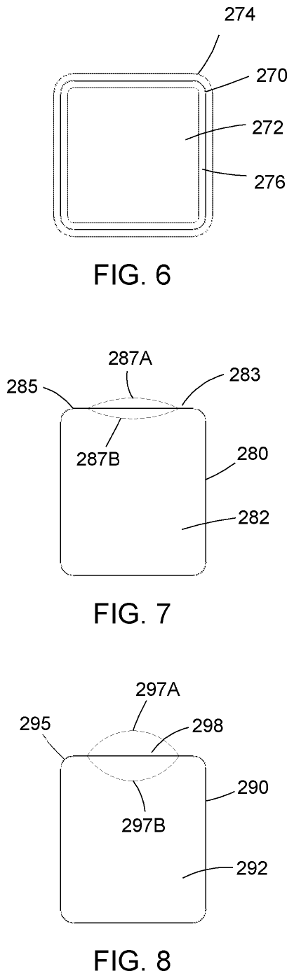

However, it may be hard to engineer a practical tank practical material with a nonlinear coefficient of expansion that exactly matches the expansion profile of water 250 across the entire temperature range of interest. Nevertheless, it can also be seen that it is highly advantageous to make the tank from a material with a higher coefficient of thermal expansion than typical material such as Copper and Stainless Steel such that it matches or substantially matches the volumetric expansion of the liquid heat storage medium as closely as possible over the temperature range of interest. In this case, some form of expansion capability would therefore still be required but it can be significantly smaller and cheaper. Accordingly, in another example, the tank is made of a material of a much higher coefficient of linear thermal expansion such that, as shown in FIG. 6, the tank 270 containing the liquid heat storage medium 272 expands considerably to a larger size when heated up 274 and shrinks to a considerably smaller size when cooled down 276, more closely matching the expansion and contraction of the liquid heat storage medium 272.

An example of the thermal expansion response of a tank made of such a material is also shown in the graph FIG. 3 254, in which the tank is formed from a plastics material in the form of polypropylene (sometimes abbreviated as PP). In this example, the tank material expands in a linear fashion between 10° C. to 95° C. such that a 1000 litre tank at 10° C. expands to just over 1040 litres at 95° C. However, such a profile means that, despite the start and end volumes being similar, the expansion system still has to accommodate approximately 10 litres of difference across much of the range between approximately 40° C. to 70° C. However, as some form of expansion vessel is required for this case, in this example it can be seen that it is advantageous to reduce initial volume of the tank such that is brings the water expansion curve 250 into much closer alignment with the tank expansion profile 254 such that the size of the expansion system can be minimised.

Such a case is shown in FIG. 4. At 10° C. the tank has slightly smaller volume than the water it contains, as the water 250 and tank 254a are heated to just over 20° C. the volumes become identical. As they are heated further the tank has a slightly larger volume than the water until they are again identical at just over 80° C. Thereafter, the tank volume again becomes smaller than the water within it. The important result of this is that the difference in volume only a few litres across the entire temperature range 10° C. to 95° C. making it much smaller, simpler and cheaper, and making it easily integrated it directly into the tank itself, rather than it being a separate system.

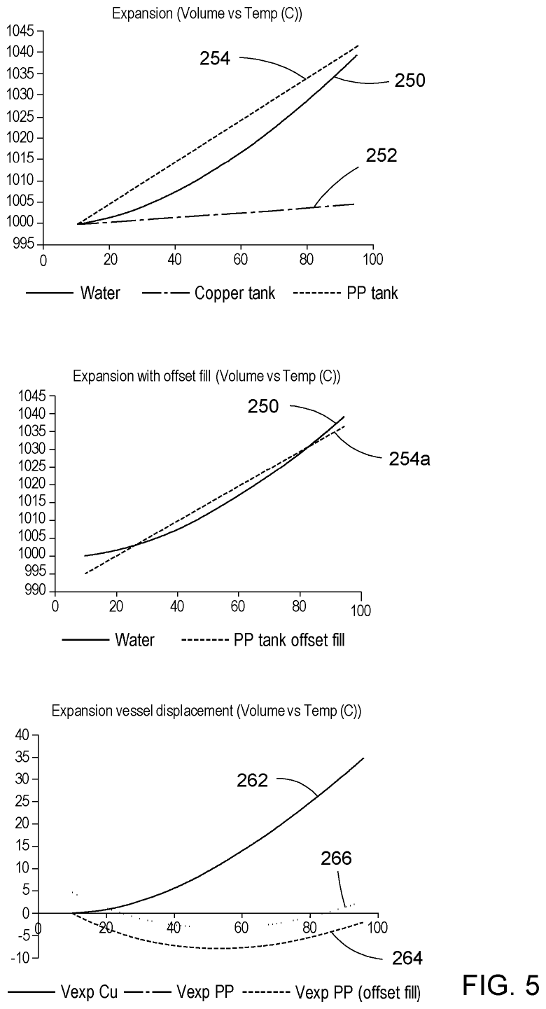

These effects are more clearly illustrated in FIG. 5 which shows the difference in volume between the tank and the water for the case shown in FIG. 3, with a tank being made of Copper 262 and made of a common engineering thermoplastic 264, for the case that they all start with a volume of 1000 litres at 10° C. Also shown is the difference in expansion volume for the case shown in FIG. 6 where the engineering thermoplastic tank is made slightly smaller than the starting volume at of water at 10° C. 266 in order to minimise the size of the expansion volume that is required. As can be seen more clearly than in FIG. 6, for this case the thermoplastic tank only requires expansion system able to cope with a difference of a few litres, compared to approximately 35 litres for the case of the Copper tank 262. The design of the tank, in conjunction with the properties of the engineering materials used to make it, can be optimised such that this differential expansion volume may be reduced even further or perhaps even eliminated.

Integrating the expansion system into the tank design and eliminating any water free surface will also mean that evaporation and thermal losses from this system can be markedly reduced and effectively eliminated. Furthermore, the substantial reduction in size of the required expansion system means that the tank can be readily designed to operate over a significantly higher temperature range, substantially increasing the energy that can be stored by a given volume of liquid heat storage medium.

Accordingly, with reference to FIGS. 7 & 8 there is provided a means of allowing the tank 280, 290 filled with a liquid heat storage medium 282, 292 to expand and contract further than that provided by the inherent thermal expansion properties of the tank material itself without a significant change in the internal pressure.

In one preferred embodiment shown in FIG. 7 this can be effected by including features 283 in one or more of the tank 280 walls, preferably but not necessarily the top surface 285, that allow it to more easily flex and bulge in either direction as shown 287A, 287B and the liquid heat storage medium 282 expands and contracts as it is heated and cooled. Such a feature 283 is referred to as a flexible wall portion and may include locally thinner walls and/or locally non-flat sections such as ripples or corrugations to reduce the local stiffness. Typically such a system would be provided on the top face of the tank 285 so as to avoid any issues with the static pressure generated by the self-weight of the liquid heat storage medium, but this is not necessarily the case.

In another preferred embodiment shown in FIG. 8, the flexible wall portion can be provided in the form of part or all of one or more of the faces of the tank 290 being formed using a thin membrane 298 of a different material that is significantly more elastic in its behaviour, such as a rubber material. This allows the membrane 298 to easily stretch and distend in either direction as shown 297A & 297B with very little change in the pressure in the tank 290 and liquid heat storage medium 292 as it does so. Typically such a membrane 298 would be provided on the top surface 295 of the tank so as to avoid any issues with the static pressure generated by the self-weight of the liquid heat storage medium, but this is not necessarily the case.

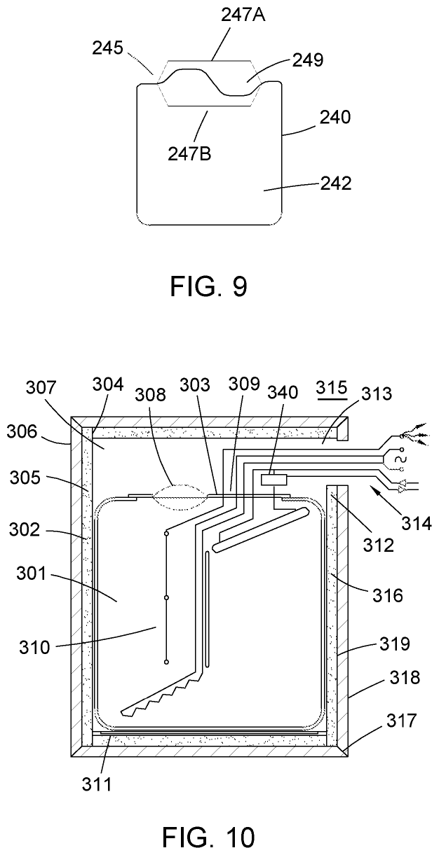

In another preferred embodiment shown in FIG. 9 the flexible wall portion can be provided in the form of part or all on one or more of the faces of the tank 240 being formed by a loose, shaped, bag of flexible material 249 which can accommodate changes in volume solely by locally flexing and changing its shape and form in either direction 247A & 247B rather than by stretching significantly, almost eliminating any pressure change in the tank 240 and liquid heat storage medium 242 as it does so. Typically such flexible bag 249 would be provided on the top surface 245 of the tank so as to avoid any issues with the static pressure generated by the self-weight of the liquid heat storage medium, but this is not necessarily the case.

In an adaptation of this last two embodiments, the material making up the shaped bag of flexible material 249 can also be made of rubber and have the ability to stretch considerably like the membrane 298 allowing it to accommodate volume change through a mixture of changing its form and shape and by stretching. This will allow it to accommodate considerably more volume change than either approach on their own, or alternatively allow it to accommodate the required volume change while taking up a much smaller proportion of the surface area of the tank 240 making it easier to integrate and cheaper to make.

A final thermal expansion related feature is described with reference to FIGS. 12A and 12B. It is a feature of many materials that exhibit a high coefficient of linear thermal expansion, such as engineering plastics, that they also start to lose their mechanical strength as they are heated up. In the current invention, the tank may be surrounded by a support frame, for example enclosed in a rigid shell, with a lower coefficient of linear thermal expansion, with internal dimensions such that just before the tank 330 and liquid heat storage medium (not labelled in FIGS. 12A and 12B) reach the maximum designed or desired temperature, the side walls of the tank come into contact with the insulating shell walls in a manner that allows the insulating shell to provide mechanical and structural support to the side walls of the tank. This is important when the strength and rigidity of the material that the tank 330 is manufactured have a tendency to reduce as the temperature is increased, as is common with materials with a high coefficient of linear thermal expansion.

The form of the design of the tank is tailored to be ideal for dramatically reducing the losses from the heat store. The substantially cuboid form of the tank and the fact that it contains or incorporates all of the features required for it to operate, with no external components or systems to accommodate, makes it possible to enclose the whole system in a hyper-insulating shell. It will be understood that the hyper-insulating shell can also function as the support frame.

With reference to FIG. 10 the tank including liquid heat storage medium (labelled 301 in combination) as previously described above is surrounded in insulation material in the form of an insulation layer, specifically an inner high performance insulating shell 302, also of substantially cuboid form, made from a high performance insulation material, for example the highest performance insulation material available at the time. Currently, for example, this is in the form of flat vacuum insulating panels known as VIPs, of one of various types and construction. The compact nature of the heat store 301, with no connections or penetrations apart from on the top face 303 can be surrounded on all six sides by a closefitting set of VIP panels 302, leaving no airgaps where their edges intersect orjoin 304. While VIPs and other high performing insulating materials are available in many forms and shapes, it is well known that the highest performing and lowest cost form is flat rectangular panels with square edges. By careful choice of dimensions it is possible to make a closely fitting box or shell 305 from such VIP panels in such a way that they interlock each other if only held together by a further close fitting support case on the outside 306. This strategy means there are no mounting systems or other potential thermal bridges that span the edges or corners of the VIP panels or their intersection with others.

The internal height of the inner high performance insulating shell is design just large enough to form a space 307 to accommodate the heat store 301 tank with it's expansion at the maximum operating temperature, the excursion of any further thermal expansion features 308 such as those described previously, the pipe fittings and connections 309 on the top face 303, and wiring and connections for any other sensors and equipment 310. The internal height of the inner high performance insulating shell is kept to a minimum while achieving this so as to minimise the volume of air encased between the tank outer surfaces and the inner faces of the inner high performance insulating shell to minimise losses from the expansion and contraction of said trapped air.

The heat store 301 sits flat on the bottom face of the inner high performance insulating shell 302, either directly on the insulation or on a load spreading plate that sits between the two 311. FIGS. 12A and 12B show the heat store 301 sitting within the inner high performance insulating shell 305 looking from above. FIG. 12A shows the heat store 301 at a low temperature, and FIG. 12B shows the heat store 301 at its maximum designed or desired operating temperature. Around the side faces of the heat store 301, the internal dimensions of the inner high performance insulating shell 302 are designed just large enough to accommodate the thermal expansion of the heat store 301 such that it accurately fits 320 the outer dimensions of the heat store 301 on all sides, with no significant gaps, when it is at its maximum designed or desired operating temperature (FIG. 12B). This is to minimise the volume of air encased between the tank outer surfaces and the inner faces of the insulating shell to minimise losses from the expansion and contraction of said trapped air, and to, as discussed previously, provide mechanical and structural support to the tank walls at higher heat store temperatures. As the heat store 301 cools down below the maximum designed or desired operating temperature it shrinks such that an air space 321 opens up between the tank 330 walls and the inner faces of the inner high performance insulating shell as shown.

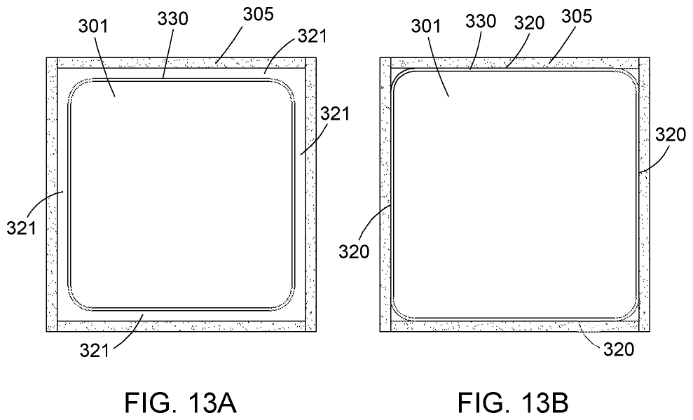

With reference to FIG. 13, in one embodiment, the heat store 401 may sit on a thin layer of low friction material 423 such as PTFE to enable it to slide more easily within the small clearances as it changes its size as it heats and cools. The thin layer of low friction material may be in addition to or instead of the load spreading plate 411 described earlier. In another embodiment a small amount of low friction lubricant may be added to the bottom of the heat store 401 tank 430 to have the same effect. In a further embodiment a locating boss or bosses 422 may be provided at a fixed point within the inner high performance insulating shell 402, close to the middle of the heat store 401 tank 430. The boss or bosses 422 locate in a recess or recesses 423 in the bottom of the tank 430 forcing the heat store 401 tank 430 to remain centred within the inner high performance insulating shell 402 and ensuring it moves equally in each direction 424 as it expands and contracts.

Returning to FIG. 10, the panels making up the walls of the inner high performance insulating shell 302 are close fitting and pressed together on all edges, for example 304, apart from all or part of one edge running along one of the top edges of the insulating shell 312. On this edge an open slot 313 is left, typically with the smallest dimension possible to let the various pipes and wires 314 required for function of the heat store 301 to pass through. This feature is known as the low loss exit 313. The low loss exit 313 also provides the only route for air within the space inside the insulating shells 307 to communicate with the air outside the system 315, this is to allow for the small flows of air that will result from changes in in the temperature inside relative to the temperature outside the insulating shells 302 & 316.

A thermostatic mixing valve 340 is provided within the region defined by the inner high performance insulating shell 302. The thermostatic mixing valve 340 has a first input connected to a supply of unheated water, and a second input connected to an output of the heat exchanger (not labelled in FIG. 10). The input of the heat exchanges is also connected to the supply of unheated water. An output of the thermostatic mixing valve 340 is connected to a hot water service outside the apparatus, and passes through the open slot 313.

As explained above it is typically important that the edges and intersections of the panels 304 making up the high performance insulating shell 302 are pressed closely together in order to effectively make the edges and intersections, for example 304 substantially airtight, with no thermal bridges or leak paths. In addition, it is very important to protect the inner high performance insulating shell 302 from potential puncture or other damage that may reduce its insulation performance. In the case of an inner high performance insulating shell 302 made of VIPs this is critically important to maintain insulating performance. Also, it is important to provide the heat store 301 with adequate structural and mechanical strength to resist the loads in service arising from various sources, and to isolate the inner high performance insulating shell 302 from these to prevent damage or degradation. Finally, it is advantageous to increase the insulating properties of the overall system by making the outer protective shell from a material that also has high performance insulation properties but that is more robust and damage tolerant.

With reference to FIG. 10 in one preferred embodiment of the current invention this is achieved by providing an outer protective insulating and structural shell 316 made from a more robust and damage tolerant material that also has high performance insulation properties. This outer protective insulating and structural shell 316 is designed to press inwards on the inner high performance insulating shell 305 to ensure that all of the edges and intersections, for example 304, are pressed together as described above.

In one embodiment, not shown, this can be achieved with a series of brackets and clamps. In a further, preferred embodiment, this is achieved by making the outer protective insulating and structural shell 316 panels from a rigid, strong, yet cheap mass produced material, for example polyisocyanurate insulation panel well known as ‘PIR’. In a preferred embodiment each edge of each panel 317 is cut at an angle of approximately 45 degrees Celsius and are made slightly undersize to minimise any thermal bridges formed by the metalised skin often applied to PIR panels. The whole structure is assembled and then put into compression by binding the outside surfaces 318 tightly with a tape material that possesses high tensile strength, low stretch, low creep and long life characteristics. Preferably, the tape material is a of a self-adhesive nature to allow it to adhere directly to the outside surfaces 318 of the outer protective insulating and structural shell 316. In one preferred embodiment, said tape is a self-adhesive fibre-reinforced ‘cross-weave’ filament tape. The fibre-reinforcement materials may be made of glass-fibre or polyester, or they may be made of any other suitable material. The cumulative tension applied to the tape presses in the various insulating layers to close all gaps and provide a very rigid, lightweight, and low cost overall structure using the minimum of materials and parts, with no unnecessary thermal bridges across the layers of insulating materials.

Once fully wrapped with one or more layers of tape an outer skin is formed around the outer protective insulating and structural shell 316 that has high tensile strength that will efficiently resist outward bowing of the sides as well as holding the assembly tightly together. The tape also effectively closes off any air paths from the inside to the outside of the shell rendering it essentially sealed and airtight, apart from the small intentional gap for the low loss exit 313 slot. Compressive strength of the inner face 319 of the outer protective insulating and structural shell 316 material works with the low stretch tape on the outer face to form an extremely lightweight and rigid composite structural panel. In some embodiments, flexural stiffness and strength can be further enhanced by bonding or otherwise attaching a thin layer of material with a very high compressive strength to some or all of the area of the inner faces 319 of the outer protective insulating and structural shell 316 panel material. Through a combination of additional layers of tape on the outside surfaces 318 and addition of more compressive material to the inner faces 319 a structural panel of essentially any mechanical properties can be made with this system. This structural system is also easy and cheap to manufacture, and to repair in the event that it does become damaged. A key part of the function, performance, light-weight and material-efficiency of the current invention is the use of the insulating materials as a key part of the structural and support function as well. This minimises use of materials and virtually eliminates thermal bridges and thereby reduces heat losses to an absolute minimum.

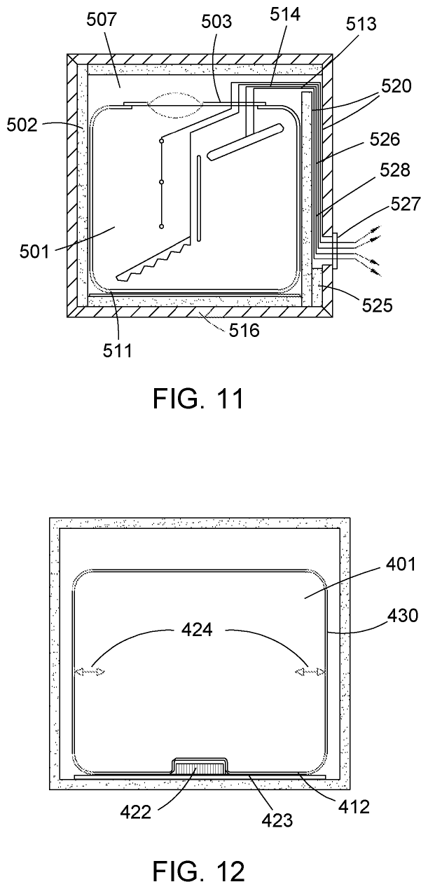

In a further improved and preferred embodiment, as shown in FIG. 11, which is the same as described with reference to FIG. 10, apart from the hereinafter noted differences, the outer protective insulating and structural shell 516 is modified in form to further enhance the insulating properties of the whole system. With reference to FIG. 11, the embodiment provides a small gap 520 between the inner high performance insulating shell 502 and the outer protective insulating and structural shell 518 on the side of the system that has the low loss exit 513. The gap is mostly filled with further high performance insulating material 525 only leaving a narrow, substantially vertical channel running down said side of the shell known as the low loss conduit 526. In this way the low loss conduit 526 is made to allow at all the required pipes and wires 514 to be even better insulated using the same low cost, high-performance flat insulating materials and construction method. It is important to maximise the performance of the current invention that the low loss conduit 526 is made as small ins dimensions and cross-sectional area as possible and that is runs a significant length down between the insulating shells to exit near the bottom. This means that warm air in the main space occupied by the tank 507 is trapped inside under the now closed and sealed upper portion of the shell. This is important to minimise losses from the system due to escaping warm air through convection. The low loss conduit 526 also provides a much increase path length for the pipes and wires entering and exiting the system which further minimises heat loss through conduction through the material comprising the pipes and wires 514 or through conduction and convection of the liquid heat storage medium within the pipes. In this embodiment the low loss conduit 526 preferably provides the only route for air within the insulating shell 507 to communicate with air outside the system 315, this is to allow for the small flows of air that with result from changes in in the temperature inside with the minimum heat loss from the heat store 501.

All of the pipes and wires 514 runs down this long thin low loss conduit 526 before exiting through a small hole exiting outwards through the other protective insulating shell. In a preferred embodiment the pipes and other services are, wherever possible, made from a material that minimises the conduction of heat down their length. In one preferred embodiment the pipes are made of a suitable plastic material for the majority of their length from the point they enter the low loss exit 513 to the point they exit the low loss conduit 526, 527. In this way, loss of heat from the heat store 501 through conduction is minimised.

Typically, each pipe is provided with a one-way valve 528 at the lower end of the low loss conduit 526, near where it exits 527 the outer protective insulating and structural shell 516. The one-way valve 528 on each pipe is designed and oriented so that it that passively opens when flow is admitted in the intended direction, but then passively closes when the flow stops and is lightly held shut by a spring or other means. The addition of the one-way valves has the important benefit that it prevents the warm liquid heat storage medium and in the pipes in the low loss conduit 526 losing heat through convection or unintended small flows driven by a process called thermo-syphoning of fluid in the system that the heat store 501 is connected to.

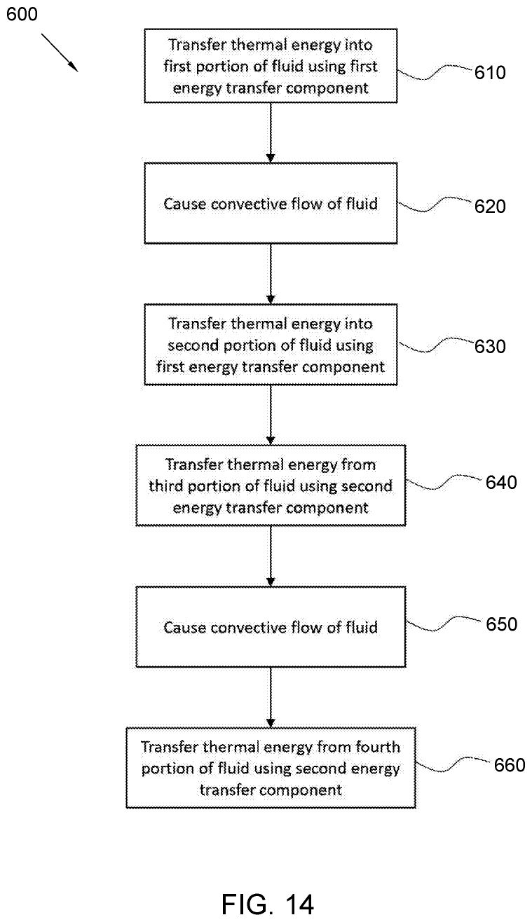

FIG. 14 illustrates a flow chart corresponding to a method 600 of the present disclosure, to be carried out by the energy storage apparatus described herein. The method 600 comprises transferring 610 a first quantity of thermal energy from the first energy transfer component into a first portion of the thermal energy storage fluid in the storage tank. The method 600 further comprises causing 620 convective flow of the thermal energy storage fluid in the storage tank such that the first portion of the thermal energy storage fluid is replaced by a second portion of thermal energy storage fluid at a lower temperature than the first portion of thermal energy storage fluid. The method 600 further comprises transferring 630 a second quantity of thermal energy from the first energy transfer component into the second portion of the thermal energy storage fluid in the storage tank. The method 600 may subsequently, alternatively or in parallel also comprise the steps of transferring 640 a third quantity of thermal energy to the second energy transfer component from a third portion of the thermal energy storage fluid in the storage tank, causing 650 convective flow of the thermal energy storage fluid in the storage tank such that the third portion of the thermal energy storage fluid is replaced by a fourth portion of thermal energy storage fluid at a higher temperature than the third portion of thermal energy storage fluid, and transferring 660 a fourth quantity of thermal energy into the second energy transfer component from the fourth portion of the thermal energy storage fluid in the storage tank.

It will be understood that although a heat store has been described, the system could instead function as a cold store by actively cooling the thermal energy storage fluid. In a further adaptation the same unit could be made to be alternately a heat store and a cold store, by adding additional components.

In temperatures described herein, the unit is Celsius, unless otherwise stated.

In summary, there is provided an energy storage apparatus. The energy storage apparatus comprises a storage tank (100, 220) for receiving thermal energy storage fluid (103, 203) therein, a first energy transfer component (107, 205) and a second energy transfer component (106, 206). The storage tank has a first portion and a second portion, each portion having a first end vertically spaced from a second end. The first portion is in fluid communication with the second portion at the respective first ends and at the respective second ends. The first energy transfer component is configured to transfer thermal energy into thermal energy storage fluid in the first portion of the storage tank. The second energy transfer component is configured to transfer thermal energy from thermal energy storage fluid in the second portion of the storage tank. The energy storage apparatus is configured such that operation of at least one of the first energy transfer component and the second energy transfer component causes convective fluid flow of the thermal energy storage fluid from the first energy transfer component towards the second energy transfer component and from the second energy transfer component towards the first energy transfer component.

Throughout the description and claims of this specification, the words “comprise” and “contain” and variations of them mean “including but not limited to”, and they are not intended to and do not exclude other components, integers, or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, or groups described in conjunction with a particular aspect, embodiment, or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. An energy storage apparatus comprising:
a storage tank for receiving thermal energy storage fluid therein and having a first portion and a second portion, each portion having a first end vertically spaced from a second end, wherein the first portion is in fluid communication with the second portion at the respective first ends and at the respective second ends;
a first energy transfer component configured to transfer thermal energy into thermal energy storage fluid in the first portion of the storage tank; and
a second energy transfer component configured to transfer thermal energy from thermal energy storage fluid in the second portion of the storage tank,
wherein the energy storage apparatus is configured such that operation of at least one of the first energy transfer component and the second energy transfer component causes convective fluid flow of the thermal energy storage fluid from the first energy transfer component towards the second energy transfer component and from the second energy transfer component towards the first energy transfer component,
wherein the energy storage apparatus further comprises a controller configured to operate at least one of the first energy transfer component and the second energy transfer component in accordance with a demand signal indicative of a thermal energy transfer request for the energy storage apparatus, and
wherein the controller is configured to operate the at least one of the first energy transfer component and the second energy transfer component in accordance with the demand signal such that a difference between an average temperature of the thermal energy storage fluid in an upper portion of the storage tank and an average temperature of the thermal energy storage fluid in a lower portion of the storage tank is less than 20 degrees Celsius during operation.

2. The energy storage apparatus of claim 1, wherein the first energy transfer component is a resistive heater.

3. The energy storage apparatus of claim 1, wherein the second energy transfer component is a heat exchanger, optionally comprising a plurality of fins.

4. The energy storage apparatus of claim 1, wherein the first energy transfer component is configured to transfer thermal energy to a lower region of the first portion.

5. The energy storage apparatus of claim 1, wherein the second energy transfer component is configured to transfer thermal energy from an upper region of the second portion.

6. The energy storage apparatus of claim 1, wherein the first energy transfer component and the second energy transfer component are provided in the storage tank.

7. The energy storage apparatus of claim 6, wherein a first connection to the first energy transfer component and a second connection to the second energy transfer component are provided through an upper wall of the storage tank.

8. The energy storage apparatus of claim 1, wherein a region of the first portion is separated from a region of the second portion, the regions being between the respective first and second ends of each of the first and second portions of the storage tank, wherein the region of the first portion is separated from the region of the second portion by a baffle in the storage tank.

9. (canceled)

10. The energy storage apparatus of claim 8, wherein the baffle extends across the region of the first portion and the region of the second portion, and wherein a first flow path for thermal energy storage fluid is provided between the region of the first portion and the region of the second portion, around the baffle and via the second ends of the first and second portions, and a second flow path for thermal energy storage fluid is provided between the region of the first portion and the region of the second portion, around the baffle and via the first ends of the first and second portions.

11. The energy storage apparatus of claim 1, further comprising one or more temperature sensors for outputting a signal indicative of a temperature of a thermal storage fluid in the storage tank.

12-13. (canceled)

14. The energy storage apparatus of claim 1, wherein the thermal energy storage fluid is configured to remain substantially within the storage tank during transfer of thermal energy between the thermal energy storage fluid and one or both of the first energy transfer component and the second energy transfer component.

15. The energy storage apparatus of claim 1, wherein the storage tank comprises a flexible wall portion.

16. (canceled)

17. An energy storage apparatus comprising:
a storage tank for receiving thermal energy storage fluid therein; and
a first energy transfer component configured to transfer thermal energy between the thermal energy storage fluid in the storage tank and the first energy transfer component,
wherein the storage tank is formed from a material having a linear coefficient of thermal expansion of greater than 30×10⁻⁶ at 20 degrees Celsius.

18-19. (canceled)

20. An energy storage apparatus comprising:
a storage tank for receiving thermal energy storage fluid therein; and
a support frame (e.g. tank) having the storage tank received therein,
wherein the storage tank is formed from a first material having a first linear coefficient of thermal expansion, and the support frame is formed from a second material having a second linear coefficient of thermal expansion, and wherein the first linear coefficient of thermal expansion is greater than the second linear coefficient of thermal expansion.

21. The energy storage apparatus of claim 20, wherein at a first temperature, a first wall of the storage tank is configured to be spaced from the support frame, and at a second temperature, greater than the first temperature, the storage tank is configured to have expanded such that the first wall of the storage tank is braced against the support frame.

22. The energy storage apparatus of claim 1, further comprising insulation material surrounding the storage tank, wherein the insulation material defines a conduit between the storage tank and an external environment outside the energy storage apparatus, wherein the conduit has a first end, open towards the storage tank, at an upper end of the storage tank, and a second end, open to the external environment, below the first end, the conduit defined by an inner wall separating the conduit from the storage tank, and an outer wall separating the conduit from the external environment.

23. (canceled)

24. The energy storage apparatus of claim 1, wherein the storage tank is cuboidal.

25. The energy storage apparatus of claim 1, configured to maintain the thermal energy storage fluid below a maximum operating temperature of between 70 degrees Celsius and 98 degrees Celsius.

26. The energy storage apparatus of claim 1, further comprising the thermal energy storage fluid in the storage tank, and wherein the thermal energy storage fluid is a liquid, optionally comprising water.

27. The energy storage apparatus of claim 1, wherein, during a temperature change of the thermal energy storage fluid between a minimum operating temperature of the thermal energy storage fluid and a maximum operating temperature of the thermal energy storage fluid, the thermal energy storage fluid is under a negative pressure in the storage tank at a first temperature and is under a positive pressure in the storage tank at a second temperature, different to the first temperature.

28.-29. (canceled)
